(19) United States
(12) Patent Application Publication
(10) Pub. No.: US 2010/0115415 A1
(43) Pub. Date: May 6, 2010

(54) GRAPHIC FOR NETWORK SWITCHES

(76) Inventor: James P. Hickey, Davis, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/263,080

(22) Filed: Oct. 31, 2008

(51) Int. Cl. G06F 15/177

(52) U.S. Cl. 715/736

(57) ABSTRACT

A graphical user interface representing a network switch provides graphical indicia on the status of a plurality of ports. A web page from the network switch is rendered on an end user tool such as a web browser of a computing device of a system administrator. The web page includes a communications interface configured to accept requests from the end user tool and to communicate with the end user tool. The web page also includes a graphical user interface for displaying the status of the ports with graphical indicia other than text.

### BACKGROUND

A network switch is a hardware device that joins multiple computing devices together within a network, such as one local area network (LAN). Computing devices are often coupled to the network switch at one of several wireless or wired ports and information from the computer devices are passed to other computing devices or to a network. Network switches are often characterized as generally operating in at least layer two, i.e., the data link layer, of the Open Systems Interconnection Basic Reference Model (OSI Model). Network switches generally contains more intelligence than passive network devices. For example, network switches are capable of inspecting data packets as they are received, determining the source and destination device of each packet, and forwarding them appropriately. A network switch conserves network bandwidth and offers generally better performance than a passive network device by delivering messages only to the connected devices intended to receive the message rather than to all connected devices.

Network switches can be configured to send status information of the switch or of the to a network administrator who can review operation of and trouble shoot the network switch. Per port status information is typically conveyed to the administrator in a series of text lines describing the information regarding each port of the network switch. As network switches become larger and more complex, providing per port status information in a meaningful and useful way becomes increasingly more difficult. In a switch with hundreds of ports, reporting status can take hundreds of lines of text. A network administrator is often required to review each of these lines to find a specific item in a line, and is often required to compare several lines including the same or similar item.

An attempt to solve this problem has been the inclusion of a filter function to the textual status of listings. The administrator is able to display the status of each port, but also filter out those lines that match a selected string. For example, a filter placed on the string “blocking” would list only those ports that are in the blocking state. This solution is often inadequate as the port status for some features can be several different values where all of them may be of interest to the administrator. An example includes the Spanning Tree Protocol use in network switching, where a port can include several different states other than normal.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a schematic drawing illustrating an example environment of a network switch of the present disclosure.

FIG. 2 is a schematic drawing illustrating an example system to provide status of the network switch of FIG. 1.

FIG. 3 is a schematic drawing illustrating an example web site configured to provide the status of the network switch in the example system of FIG. 2.

FIG. 4 is a schematic drawing illustrating a first example screen view of the web site of FIG. 3.

FIG. 5 is a schematic drawing illustrating a second example screen view of the web site of FIG. 3.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise.

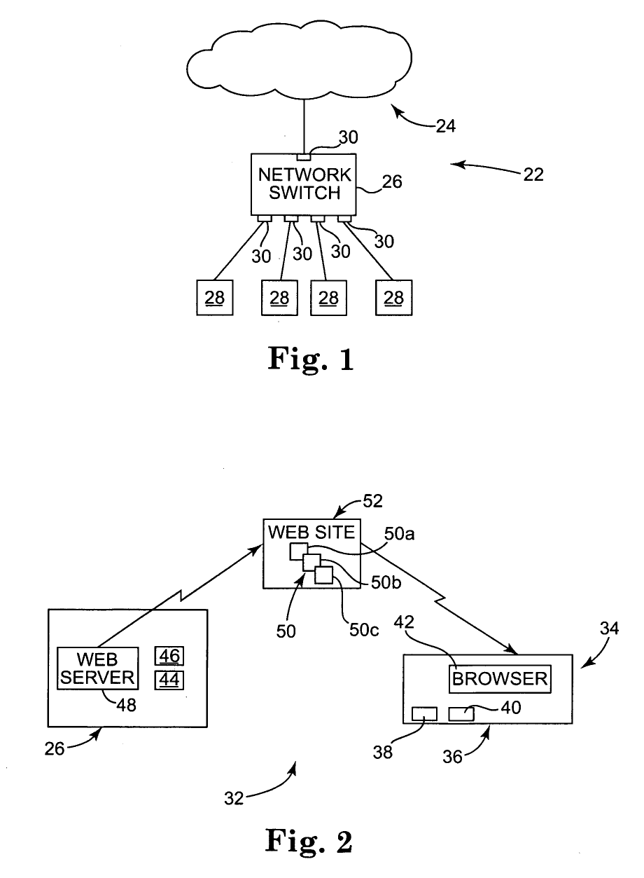

FIG. 1 illustrates an example environment of the present disclosure. The environment includes a local area network 22 communicatively coupled to another network 24 such as a wide area network, another local area network, or the Internet. The local area network 22 includes a network switch 26 that is used to couple a plurality of computing devices 28 together in the network 24. The computing devices 28 can be directly coupled to the network switch 26, or local area network can include devices (not shown) interposed between the computing devices 28 and the network switch 26 at ports 30. Depending on the requirements of the network 24 and the capabilities of the network switch 28, the network switch can be coupled directly to the other network 24 or to the other network 24 through one or more devices (not shown). Also, several network switches can be chained together to provide additional capabilities in the network 22. In one example, the network switch 26 includes the capabilities of the previously interposed devices, and functions as a multilayer switch.

The network switch 26 is a managed network switch, which can include one or more ways, or interfaces, for a system administrator to modify the operation of the switch. Common management methods have include a serial console or Command Line Interface (CLI) accessed via telnet or Secure Shell, an embedded Simple Network Management Protocol (SNMP) agent allowing management from a remote console or management station, and a web interface for management from an end user tool such as a web browser. Examples of configuration changes that one can do from a managed switch include enabling features such as Spanning Tree Protocol, setting port speed, and creating or modify Virtual Local Area Networks (VLANs).

Managed switches include intelligent switches and fully managed switches. An intelligent switch is a managed switch with a limited set of management features, and can include switches that are managed over the World Wide Web, or web. An intelligent switch typically provides a web interface (and usually no CLI access) and allows configuration of basic settings, such as VLANs, port-speed, and duplex from a system administrator. A fully managed switch, or an enterprise switch, has a full set of management features, including CLI Command Line Interface, SNMP agent, and web interface. The fully managed switch can include additional features to manipulate configurations, such as the ability to display, modify, backup, and restore configurations. Compared with an intelligent switch, an enterprise switch includes more features that can be customized or optimized than an intelligent switch. An enterprise switches can often be found in networks with larger number of switches and connections.

FIG. 2 illustrates an example web interface 32 between the network switch 26 and the system administrator 34 to provide information regarding the network switch 26 to the system administrator 34. In this model, the network switch operates as a server and the system administrator operates as a client. The network switch 26 can be part of the local area network 24, and the system administrator 34 can be either part of or outside of the local area network 24. The system administrator 34 is provided with a computing device 36 including a processor 38 and a memory 40 configured to operate an end user tool such as a web browser 42. The network switch 26 includes a processor 44 and memory 46 and is configured to operate as a web server 48.

The web server 48 of the example accepts hypertext transfer protocol (HTTP) requests from the system administrator web browser 42, and provides the web browser 42 with HTTP responses along with optional data contents such as web pages 50 such as HTML documents that can include linked objects from a website 52. The web pages 50 include graphical representations of the status of the ports 30 of the network switch 26.

In one example, the system administrator 34 can view the web site by typing a uniform resource locator (URL) of the web page 50 into the web browser 42. It is anticipated that the system administrator prefers to keep access to the web server 48 private. The web server 48 is protected from unauthorized access through passwords, keys, or other means. The web browser 42 initiates a series of communication messages in order to fetch and display the web pages 50. The server-name portion of the URL is resolved into an Internet protocol (IP) address using the global, distributed Internet database known as the domain name system (DNS) to contact and send data packets to the web server 48. The browser 42 requests the web pages 50 by sending an HTTP request to the web server 48 at the address. In the case of a typical web page 50, the hypertext markup language (HTML) text of the page is requested and parsed by the web browser 42, which will then make additional requests for images and any other files that form a part of the webpage. Having received the required files from the web server, the browser 42 renders the webpage onto the screen as specified by its HTML, or other web language. Any images and other resources are incorporated to produce the on-screen webpage that the user sees.

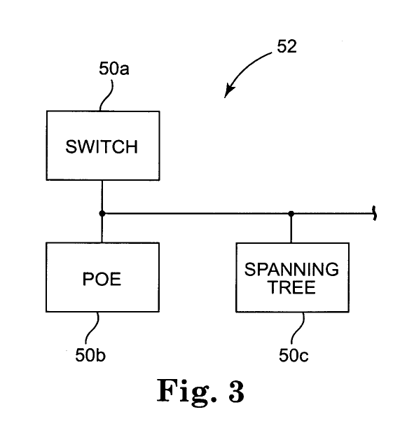

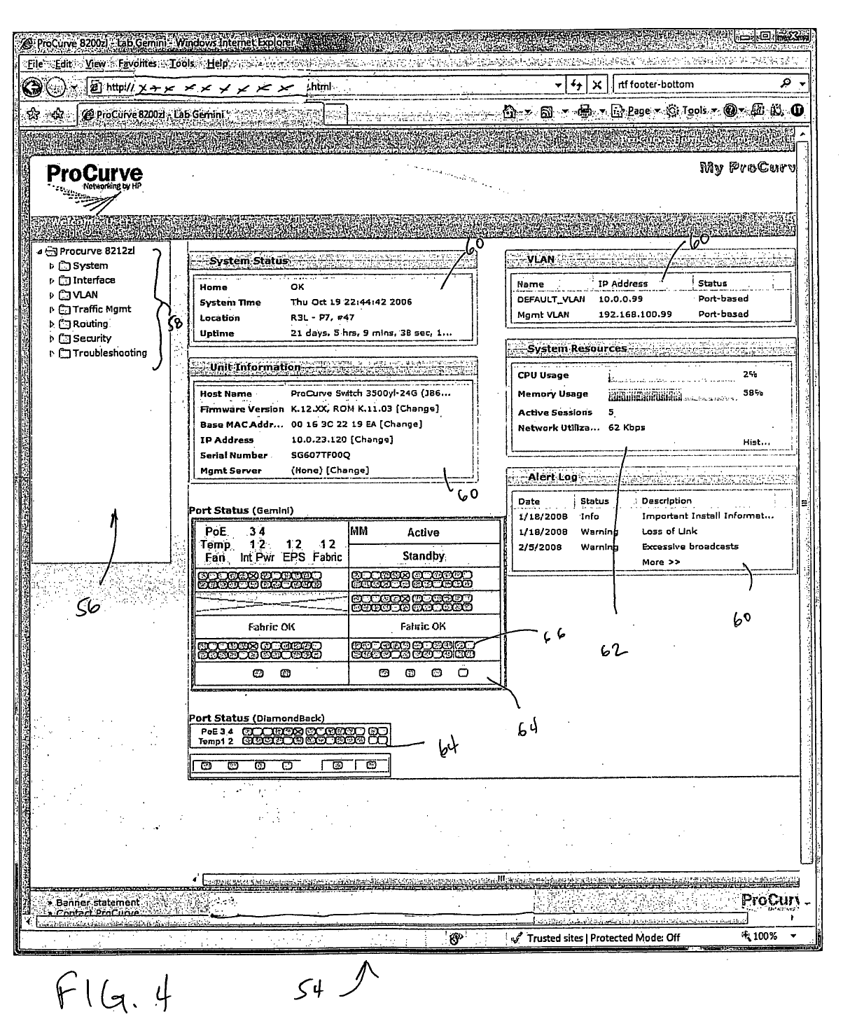

FIG. 3 illustrates an example website 52 provided by the web server 48 of the network switch 26. The website 52 includes a number of linked pages 50a, 50b, 50c, and can include additional linked pages other than those shown. Web page 50a can be configured as a general status web page. The general status web page 50a can be configured to include a graphical picture of the network switch 26. The graphical picture of the switch 26 can include a representation of the lights or light emitting diodes of the network switch 26 for each port 30. The picture of the switch can include indicia, such as a selected color assigned to the lights, to represent the status of that port where ports of similar status are provided with the same color. For example, a graphical representation of the general status webpage 50a can include a graphical representation of the ports as having one color of lights for when the port is connected and another color of lights for the when the port is not connected.

The general status webpage 50a can provide links to other web pages that can provide additional, or more detailed information or features of the ports. For example, the website 52 can include a power-over-Ethernet page 50b to indicate the power-over-Ethernet status of each port. Each port in the example can be represented by a color that indicates the power-over-Ethernet status. One color can be used to represent powered, another color can be used to represent not powered, a third color can be used to indicate power requested but not available, a fourth color can be used to indicate a fault, and so on.

The web pages 50a, 50b can also be linked to a spanning tree protocol (STP) page 50c. The indicators provide a graphical representation of the spanning tree protocol state for each port. For example, a port can be represented by one of a number of colors corresponding with an SPT state such as blocking, listening, learning, forwarding, disabled, RP, DP, and so on.

The website can be configured in a number of ways depending on the preferences of the web designer. A legend regarding the colors used and their corresponding meaning can be provided on each page. In one example, all of the pages can be accessed from any of the pages. In another example, the graphical display of indicia can be accompanied with text. In still another example, the system administrator can customize a web page to provide selected information in a selected graphical or graphical-textual format.

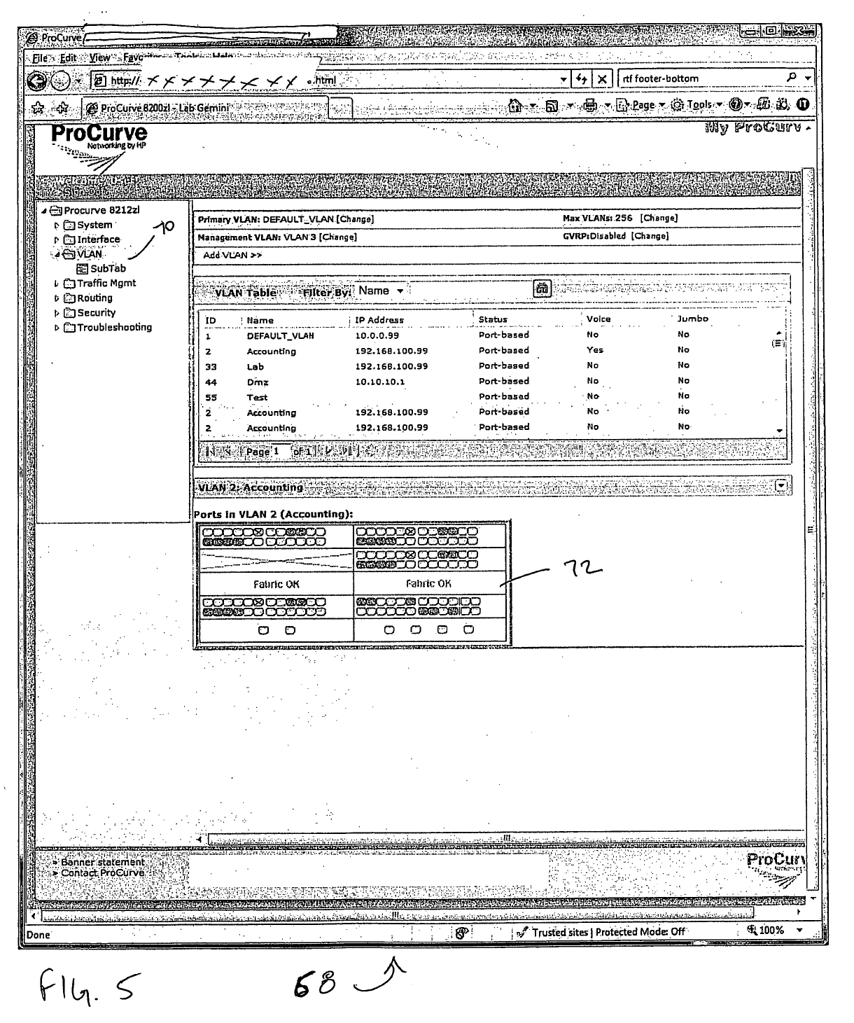

FIG. 4 provides an example webpage 54 accessed from the website 52 rendered on the system administrator's web browser 42. The web browser could be any one of several available web browsers and is not necessarily limited to a single web browser. A general status web page is shown. The web page 54 includes a navigation interface 56, which can be arranged in a familiar set of nested folders 58. The web page also includes a set of textual windows 60 to help identify system status and a textual/graphical windows 62 as well as graphical windows 64. In one example, the windows 60, 62, 64 parse out sets of relevant status information and can be linked to web pages with additional details about the particular information in the window.

Graphical window 64 includes status information by port, where lights 66 represent the ports and their status is indicated by the color of the lights. A system administrator 34 can quickly see and interpret the status information. Abnormal states of the port can also be represented with flashing lights to call the attention of the system administrator 34. The graphical nature of the representation of the ports allows the system administrator 34 to see all of the ports in a single web page 54 rather than on multiple pages of text listing. Also, the system administrator can locate ports in a similar state by noticing all ports of a particular color, rather than scanning the text for particular words.

FIG. 5 provides another example webpage 68 accessed from the website 52 rendered on the system administrator's web browser 42. Website 68 is accessed from the general status web page 54. For example, the system administrator can access web page 68 by selecting the VLAN folder in the navigation pane and selecting the page from the link 70. Again, the web page 68 includes a graphical window 72 where per port information regarding the status of VLAN is simply displayed, easy to access, and easy to understand.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A computer-readable storage medium storing computer-executable instructions for rendering a web page onto an end user tool operating on a computing device to provide information from a network switch with a plurality of ports, the computer-executable instructions comprising:
a communications interface configured to accept requests from the end user tool and to communicate with the end user tool;
a graphical user interface for displaying the status of the ports with graphical indicia other than text.

2. The computer-readable storage medium of claim 1 wherein the end user tool is a web browser.

3. The computer-readable storage medium of claim 1 wherein the web page is one of a plurality of linked web pages on a web site.

4. The computer-readable storage medium of claim 3 wherein the web page includes a navigation pane having a plurality of links to the linked web pages.

5. The computer-readable storage medium of claim 3 wherein the each of the web pages corresponds with a selected feature of the network switch.

6. The computer-readable storage medium of claim 5 wherein one of the selected features of the network switch is virtual local area network.

7. The computer-readable storage medium of claim of claim 5 wherein the selected features of the network switch of spanning tree protocol, power-over-Ethernet, and general status are represented in separate linked web pages.

8. The computer-readable storage medium of claim 1 wherein the graphical user interface is configured to appear as a representation of the network switch.

9. The computer-readable storage medium of claim 8 wherein representations of the ports on the graphical user interface are arranged in the order of the arrangement f the ports on the network switch.

10. The computer-readable storage medium of claim 8 wherein representations of the ports on the graphical user interface include presenting the representation of each of the ports as a selected color corresponding with a status of each port on the network switch.

11. The computer-readable storage medium of claim 10 wherein the web page represent power-over-Ethernet status of each port, wherein a first color is used to represent powered status, a second color is used to represent not powered, a third color is used to represent power requested but not available, and a fourth color is used to represent a fault.

12. The computer-readable storage medium of claim 1 wherein the web page is configured to protect access from unauthorized users.

13. A network switch, comprising:
a plurality of ports configured to connect to computing devices;
a processor;
a web server configured to operate on the processor and provide a graphical user interface representing the status of the ports in a graphical form.

14. The network switch of claim 13 wherein the web server is configured to be accessed by an end user tool to render a web page including the graphical user interface.

15. The network switch of claim 14 wherein the processor is configured to present the web page in a hypertext markup language.

16. The network switch of claim 13 wherein each of the ports are represented by a selected indicia and each indicia represent a selected state.

17. The network switch of claim 16 wherein the indicia is a selected color.

18. The network switch of claim 17 wherein the color is flashing.

19. A network, comprising:
a managed network switch including a plurality of ports and a web server configured to present the status of the plurality of ports as a graphical user interface;
a plurality of computing devices coupled to the ports of the managed network switch; and
a end user tool operably coupled to the web server of the managed network switch and configured to render the graphical user interface to graphically present a status of the ports on the managed network switch.

20. The network of claim 19 wherein the managed network switch and the plurality of computing devices are coupled together as a local area network, and the end user tool is outside of the local area network.
